(19) United States
(12) Patent Application Publication
(10) Pub. No.: US 2016/0127504 A1
(43) Pub. Date: May 5, 2016

(54) INFORMATION PROCESSING DEVICE, INFORMATION PROCESSING SYSTEM, PROGRAM, AND COMPUTER READABLE RECORDING MEDIUM

(71) Applicant: Sony Computer Entertainment Inc., Tokyo (JP)

(72) Inventors: Masaki Takahashi, Kanagawa (JP); Masanori Nomura, Tokyo (JP)

(21) Appl. No.: 14/885,184

(22) Filed: Oct. 16, 2015

(30) Foreign Application Priority Data
Oct. 30, 2014 (JP) 2014-221916

(51) Int. Cl. H04L 29/08

(52) U.S. Cl. CPC H04L 67/34; H04L 67/06

(57) ABSTRACT

An information processing device includes: a request transmitting unit configured to transmit a request to download contents; a condition receiving unit configured to receive download conditions of the contents in another terminal device than the information processing device; and a notification processing unit configured to notify the received download conditions to a user.

### BACKGROUND

The present technology relates to a technology for downloading contents.

A technology in related art is known which sets a timer and automatically downloads software by a timer start at a set time. Japanese Patent Laid-Open No. 2012-3329, for example, discloses a technology in which an automatic download function is started at a set time to automatically access a file providing server and automatically download system software, a patch file of a game, or a content file of demonstration game software, a game trailer (game video), or the like.

PCT Patent Publication No. WO2014/111984 (hereinafter referred to as Patent Document 2) discloses game software logically divided into a plurality of groups and formed by a plurality of files, each file belonging to at least one of the plurality of groups, and at least one file belonging to each group. In relation to this game software, it is disclosed that when an information processing device has downloaded all of files of a first group to which a program file necessary to start the game software and a data file belong, the information processing device can start the game software even if the information processing device does not download files of a second group and subsequent groups. Patent Document 2 also discloses that download progress conditions of the file group of the first group are displayed on a display for a purpose of informing a user that the user does not need to wait for a long time.

PCT Patent Publication No. WO2013/111247 discloses “remote play,” in which a user transmits game operation information to an information processing device at a remote place, and receives a game image in which the operation information is reflected in the progress of the game from the information processing device.

### SUMMARY

When the game software is downloaded as in Patent Document 2, the user is desirably able to recognize in some form that the game software has been downloaded. It is convenient for the user if a mechanism is constructed which informs the user that the game software has been downloaded even while the user is away from home, in particular.

It is accordingly desirable to realize a mechanism that can notify completion of download of software efficiently.

According to a mode of the present technology, there is provided an information processing device including: a request transmitting unit configured to transmit a request to download contents; a condition receiving unit configured to receive download conditions of the contents in another terminal device than the information processing device; and a notification processing unit configured to notify the received download conditions to a user.

Another mode of the present technology is an information processing system. This information processing system includes a first information processing device and a second information processing device. The first information processing device includes a download processing unit configured to download contents from a server and a download condition notifying unit configured to notify download conditions of the contents to the server. The second information processing device includes a request transmitting unit configured to transmit a request to download the contents to the server, a condition receiving unit configured to receive the download conditions of the contents in the first information processing device from the server, and a notification processing unit configured to notify the received download conditions to a user of the second information processing device.

Further another mode of the present technology is a program for a computer. The program includes: transmitting a request to download contents to a server; receiving download conditions of the contents in a terminal device; and notifying the received download conditions to a user.

Further another mode of the present technology is a computer readable recording medium for recording a program. The program includes: transmitting a request to download contents to a server; receiving download conditions of the contents in a terminal device; and notifying the received download conditions to a user.

Arbitrary combinations of the above constituent elements as well as modes obtained by converting expressions of the present technology between a method, a device, a system, a recording medium, a computer program, and the like are also effective as modes of the present technology.

According to the present information processing technology, it is possible to realize a mechanism that can notify completion of download of software efficiently.

### BRIEF DESCRIPTION OF THE DRAWINGS

FIG. 1 is a diagram showing an information processing system according to an embodiment;

FIG. 2 is a diagram showing functional blocks of a first information processing device;

FIG. 3 is a diagram showing a configuration of the first information processing device;

FIG. 4 is a diagram showing a configuration of a second information processing device;

FIG. 5 is a diagram showing a configuration of a notifying server;

FIG. 6 is a diagram showing a sequence of remote download processing;

FIG. 7 is a diagram showing a download progress screen displayed on the second information processing device; and

FIGS. 8A and 8B are diagrams showing examples of a screen displayed on the second information processing device.

### DETAILED DESCRIPTION OF THE PREFERRED EMBODIMENT

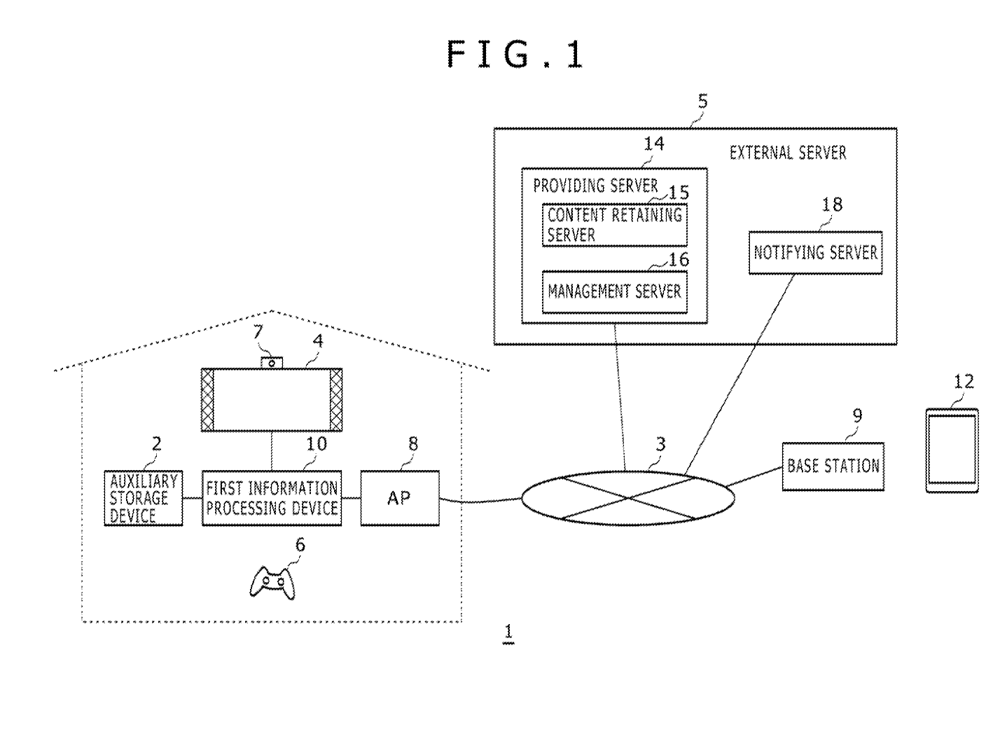

FIG. 1 shows an information processing system 1 according to an embodiment of the present technology. The information processing system 1 includes a first information processing device 10 and a second information processing device as user terminals, and an external server 5. The first information processing device 10 may be a stationary terminal device, for example a game device, that is connected to a television set at home. The second information processing device 12 may be a portable terminal device such as a mobile telephone, a smart phone, a tablet, or the like. The first information processing device 10 and the second information processing device 12 are possessed by a same user. The user can carry the portable second information processing device 12 and operate the second information processing device 12 at any time even while the user is away from home.

An auxiliary storage device 2 is a mass storage device such as a hard disk drive (HDD), a flash memory, or the like. The auxiliary storage device 2 may be an external storage device connected to the first information processing device 10 by a universal serial bus (USB) or the like, or may be an internal storage device. An output device 4 may be a television set including a display for outputting an image and a speaker for outputting sound.

A camera 7 as an imaging device is provided in the vicinity of the output device 4. The camera 7 images a space around the output device 4. FIG. 1 shows an example in which the camera 7 is attached to an upper portion of the output device 4. However, the camera 7 may be disposed on a side of the output device 4. In either case, the camera 7 is disposed in such a position as to be able to image the user playing a game in front of the output device 4. Incidentally, the camera 7 may be a stereo camera.

The first information processing device 10 is connected to an input device 6 operated by the user by radio or by wire. The input device 6 outputs operation information indicating a result of operation by the user to the first information processing device 10. When the first information processing device 10 receives the operation information from the input device 6, the first information processing device 10 reflects the operation information in the processing of system software or an application, and outputs a result of the processing from the output device 4.

In the present embodiment, the first information processing device 10 may be a game device that executes a game program, and the input device 6 may be a game controller that provides user operation information to the game device. The game controller includes a plurality of input sections such as a plurality of push type operating buttons, an analog stick allowing an analog quantity to be input, a rotary button, and the like.

An access point (hereinafter referred to as an “AP”) 8 has functions of a wireless access point and a router. The first information processing device 10 is connected to the AP 8 via radio or a wire to be communicatably connected to the external server 5 on a network 3.

Incidentally, in the information processing system 1, the second information processing device 12 can supply operation information indicating a result of operation by the user to the first information processing device 10 through the network 3, and the first information processing device 10 can reflect the operation information input on the second information processing device 12 in the processing of the system software or the application. The first information processing device 10 transmits a processing result to the second information processing device 12 through the network 3. The processing result is displayed on the display of the second information processing device 12. This function is referred to as “remote play,” which means that the user can play a game while at a remote place.

The external server 5 provides network service to the user. The external server 5 may be physically formed by a plurality of servers, and the servers may be maintained and managed by entities corresponding to the respective functions of the servers. The external server 5 includes a network server not shown in the figures. The first information processing device 10 is maintained in a state of being signed in to the network server at all times to be able to be provided with various kinds of service by the external server 5. Incidentally, while the external server 5 includes a providing server 14 and a notifying server 18 in the present example, the providing server 14 and the notifying server 18 may each be formed by a plurality of servers.

The providing server 14 includes at least a content retaining server 15 and a management server 16. The content retaining server 15 retains contents. The contents may be digital contents such as game software, moving images, music, cartoons, novels, and the like. The management server 16 mediates between the content retaining server 15 and the first information processing device 10 and between the content retaining server 15 and the second information processing device 12.

In the embodiment, when the management server 16 receives a request to download contents from the second information processing device 12, the management server 16 obtains the contents from the content retaining server 15, and places the contents in a download queue. The management server and the notifying server 18 thereafter cooperate with each other to assist in the processing of downloading the contents in the first information processing device 10. Incidentally, the download processing according to the embodiment is characterized in that the request to download contents is issued from the second information processing device 12, and in that the contents are downloaded to the first information processing device 10. The processing in which the user thus transmits a download request from the second information processing device 12 to the external server 5 and contents are downloaded to the first information processing device 10 as another terminal device will be referred to also as a “remote download” in the embodiment.

The notifying server 18 is a relay server that provides a push notification of information to the first information processing device 10 and the second information processing device 12 according to an instruction from the management server 16. The notifying server 18 has registered therein the identifying information and contact information (an address on the network 3, a telephone number, and the like) of the first information processing device 10 and the second information processing device 12 possessed by the user in association with information (account identification (ID)) identifying the user.

In the embodiment, when the notifying server 18 receives information indicating that a remote download request is made from the management server 16 together with an account ID, the notifying server 18 provides a push notification of a download instruction to the first information processing device 10. Receiving this notification, the first information processing device 10 downloads digital contents. When the first information processing device 10 completes the download, the notifying server 18 provides the second information processing device 12 with a push notification of information indicating that contents downloaded to the first information processing device 10 are in an executable state. The executable state of the contents refers to a state in which the user can play a game in a case of game software, a state in which the user can view a moving image or music, or a state in which the user can read a cartoon or a novel. When the second information processing device 12 is a terminal device using a mobile telephone line such as a smart phone or the like, the notification from the notifying server 18 is transmitted to the second information processing device 12 via a base station 9.

The second information processing device 12 displays, on the display, information indicating that the contents downloaded by the first information processing device 10 are in an executable state. When the user receives this notification and starts an application for remote operation which application is installed on the second information processing device 12, the display of the second information processing device 12 displays a graphical user interface (GUI) for accessing the first information processing device 10 from the second information processing device 12, starting the first information processing device 10, and executing the contents. Incidentally, when the contents are game software, and are capable of remote play, the display of the second information processing device 12 may display a GUI for the remote play of the contents. When the user operates the GUI, an instruction to execute the contents is transmitted from the second information processing device 12 to the first information processing device 10. The first information processing device 10 turns on main power, and executes the downloaded contents. The user can thereby operate the contents being executed by the first information processing device 10 from the second information processing device 12.

An example of a mode of use of the information processing system 1 will be shown. While the user is away from home, the user operates the second information processing device 12 as a smart phone or the like to access the management server and purchase desired contents retained in the content retaining server 15. The purchase of the contents by the user is notified from the notifying server 18 to the first information processing device 10. Receiving this notification, the first information processing device 10 accesses the management server 16, and downloads the contents. The first information processing device 10 successively reports download conditions to the management server 16. When the management server 16 determines that the contents have become executable in the first information processing device 10, the management server 16 provides a notification to the effect that the contents have become executable in the first information processing device 10 to the notifying server 18 together with the account ID. The notifying server 18 provides a push notification that the contents have become executable to the second information processing device 12 operated at the time of the purchase of the contents. The user can thereby check at a place away from home that the contents are executable in the first information processing device 10 at the home of the user through the portable second information processing device 12.

Viewing the notification, the user starts the application for remote operation on the second information processing device 12. This application for remote operation can remotely start the first information processing device 10, and instruct the first information processing device 10 to execute the contents. The first information processing device 10 thereby starts the processing of executing the contents. Incidentally, when the contents are game software, and are capable of remote play, the application for remote operation notifies the first information processing device 10 that the contents are to be played remotely. Thus the user can also remotely play the contents.

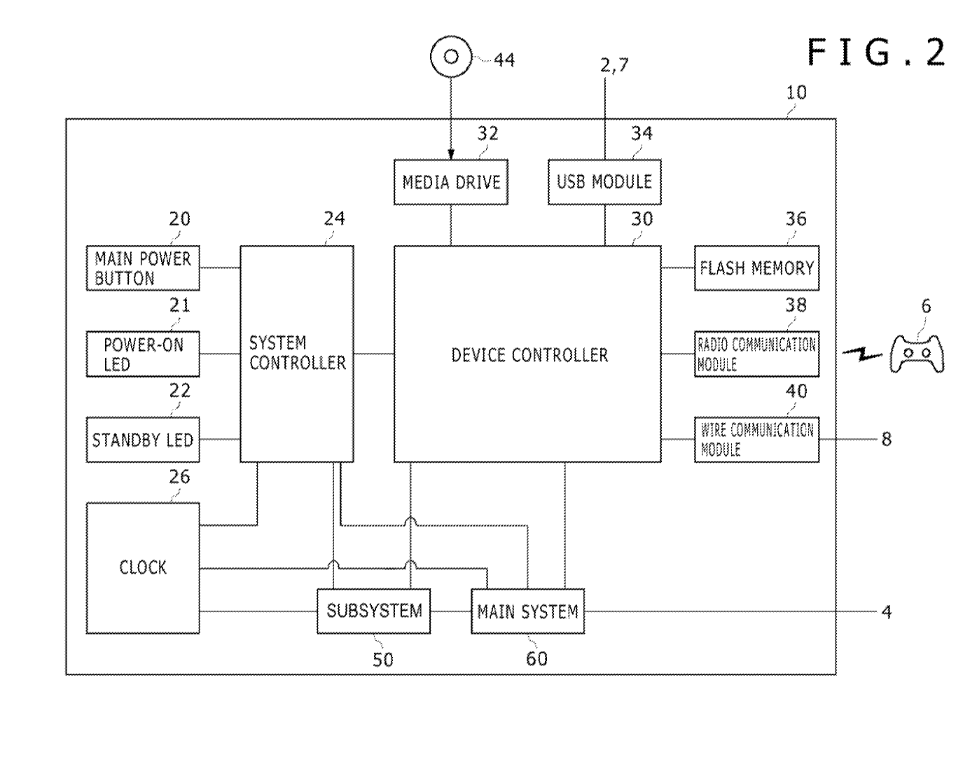

FIG. 2 is a functional block diagram of the first information processing device 10. The first information processing device 10 includes a main power button 20, a power-on light emitting diode (LED) 21, a standby LED 22, a system controller 24, a clock 26, a device controller 30, a media drive 32, a USB module 34, a flash memory 36, a radio communication module 38, a wire communication module 40, a subsystem 50, and a main system 60.

The main system 60 includes a main central processing unit (CPU), a memory as a main storage device and a memory controller, a graphics processing unit (GPU), and the like. The GPU is used mainly for arithmetic processing of a game program. These functions may be configured as a system on chip, and formed on one chip. The main CPU has a function of executing a game program recorded in the auxiliary storage device 2.

The subsystem 50 includes a sub-CPU, a memory as a main storage device and a memory controller, and the like. The subsystem 50 does not include a GPU, and does not have a function of executing a game program. The number of circuit gates of the sub-CPU is smaller than the number of circuit gates of the main CPU. The power consumption in operation of the sub-CPU is lower than the power consumption in operation of the main CPU. The sub-CPU operates while the main CPU is in a standby state. The first information processing device 10 can therefore maintain a state of being connected to the external server 5 at all times.

The main power button 20 is an input section to which an operating input from the user is performed. The main power button 20 is provided to a front surface of a casing of the first information processing device 10. The main power button 20 is operated to turn on or off the supply of power to the main system 60 of the first information processing device 10. The power-on LED 21 is lit when the main power button 20 is turned on. The standby LED 22 is lit when the main power button 20 is turned off.

The system controller 24 detects the depression of the main power button 20 by the user. When the main power button 20 is depressed while a main power supply is in an off state, the system controller 24 obtains the depressing operation as a “turn-on instruction.” When the main power button 20 is depressed while the main power supply is in an on state, on the other hand, the system controller 24 obtains the depressing operation as a “turn-off instruction.”

The clock 26 is a real-time clock. The clock 26 generates present date and time information, and supplies the present date and time information to the system controller 24, the subsystem 50, and the main system 60. The device controller 30 is configured as a large-scale integrated circuit (LSI) that transfers information between devices like a Southbridge. As shown in FIG. 2, the device controller 30 is connected with devices such as the system controller 24, the media drive 32, the USB module 34, the flash memory 36, the radio communication module 38, the wire communication module 40, the subsystem 50, the main system 60, and the like. The device controller 30 accommodates differences between electrical characteristics of the respective devices and differences between data transfer rates, and controls data transfer timing.

The media drive 32 is a drive device that is loaded with and drives a read only memory (ROM) medium 44 on which application software such as a game or the like and license information are recorded, and which drive device reads a program, data, and the like from the ROM medium 44. The ROM medium 44 is a read-only recording medium such as an optical disk, a magneto-optical disk, a Blu-ray disk, or the like.

The USB module 34 is a module connected to an external device by a USB cable. The USB module 34 may be connected to the auxiliary storage device 2 and the camera 7 by a USB cable. The flash memory 36 is an auxiliary storage device forming an internal storage. The radio communication module 38 performs wireless communication with the input device 6, for example, under a communication protocol such as a Bluetooth (registered trademark) protocol, an IEEE 802.11 protocol, or the like. Incidentally, the radio communication module 38 may support a third-generation (3rd Generation) digital mobile telephone system compliant with an international mobile telecommunication 2000 (IMT-2000) standard defined by the international telecommunication union (ITU), or may further support a digital mobile telephone system of another generation. The wire communication module 40 performs wire communication with an external device. The wire communication module 40 is connected to the external network via the AP 8, for example.

Configurations of the first information processing device 10, the second information processing device 12, and the notifying server 18 will be shown in the following.

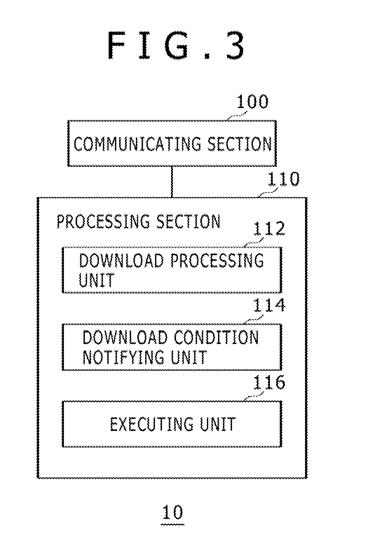

FIG. 3 shows the configuration of the first information processing device 10. The first information processing device 10 includes a communicating section 100 and a processing section 110. The processing section 110 includes a download processing unit 112, a download condition notifying unit 114, and an executing unit 116. Incidentally, the communicating section 100 exhibits the functions of the radio communication module 38 and the wire communication module 40 shown in FIG. 2.

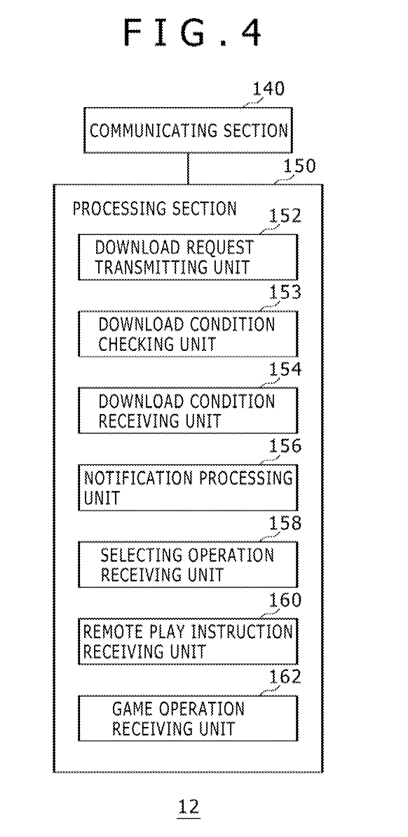

FIG. 4 shows the configuration of the second information processing device 12. The second information processing device 12 includes a communicating section 140 and a processing section 150. The processing section 150 includes a download request transmitting unit 152, a download condition checking unit 153, a download condition receiving unit 154, a notification processing unit 156, a selecting operation receiving unit 158, a remote play instruction receiving unit 160, and a game operation receiving unit 162. Incidentally, in the embodiment, the communicating section 140 is configured as a radio communication module that communicates with the base station 9 via a mobile telephone line. However, the communicating section 140 may have a wireless LAN communicating function. In addition, it is assumed in the embodiment that the second information processing device 12 is a portable terminal device. However, the second information processing device 12 may be a stationary terminal device, for example a desktop computer used at a place of work. In that case, the communicating section 140 may be connected to the network 3 by wire.

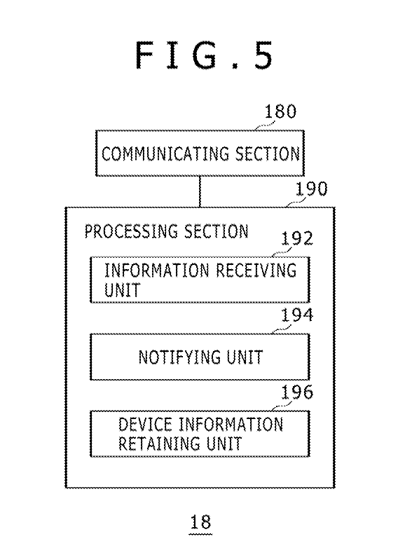

FIG. 5 shows the configuration of the notifying server 18. The notifying server 18 includes a communicating section 180 and a processing section 190. The processing section 190 includes an information receiving unit 192, a notifying unit 194, and a device information retaining unit 196.

The elements described as functional blocks performing various processing in FIGS. 3 to 5 can be configured by a circuit block, a memory, or another LSI in terms of hardware, and is implemented by a program loaded in a memory or the like in terms of software. Hence, it is to be understood by those skilled in the art that these functional blocks can be implemented in various forms by only hardware, only software, or combinations of hardware and software, and are not limited to any one of the forms.

The first information processing device 10 has the main system 60 and the subsystem 50. The subsystem 50 is in an active state even while the main system 60 is in a standby state. Therefore, even when the main power to the first information processing device 10 is off, the subsystem 50 maintains connection to the network server, so that the signed-in state of the user is maintained. Thus, the first information processing device 10 can be accessed from the external server 5 even when the main power is off.

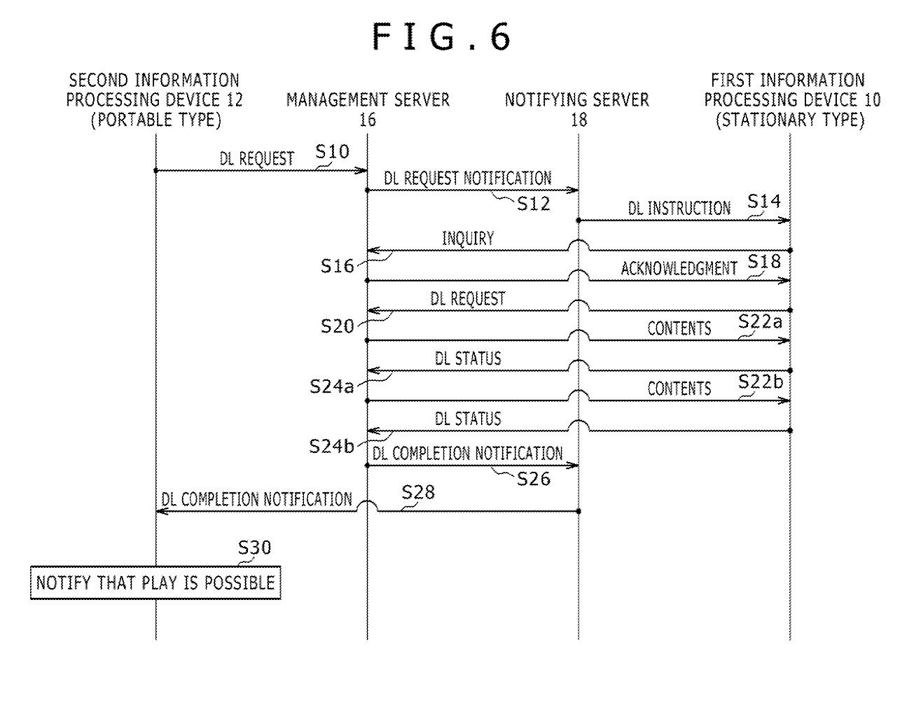

FIG. 6 shows a sequence of remote download processing in the information processing system 1.

The user operates the user interface of the second information processing device 12 to display a screen for purchasing contents provided by the content retaining server 15 on the display of the second information processing device 12. When the user selects desired contents on the purchase screen, and presses a purchase button, the download request transmitting unit 152 transmits a request to download the selected contents to the management server 16 (S10). The management server 16 obtains the contents from the content retaining server 15 and places the contents in a remote download queue, and notifies information indicating that the remote download request has been made to the notifying server 18 together with the account ID of the user (S12).

When the information receiving unit 192 in the notifying server 18 receives the account ID and the remote download request, the notifying unit 194 refers to the device information retaining unit 196, and identifies the first information processing device 10 associated with the account ID. The device information retaining unit 196 has registered therein the identifying information and contact information (an address on the network 3, a telephone number, and the like) of the first information processing device 10 and the second information processing device 12 possessed by the user in association with the account ID. The notifying unit 194 provides a push notification of a remote download instruction to the identified first information processing device 10 (S14). Incidentally, the embodiment represents a case where the user possesses one first information processing device 10. However, the user may possess a plurality of first information processing devices 10 of a same type, and the device information retaining unit 196 may have the plurality of first information processing devices 10 registered therein in association with the account ID. In that case, the notifying unit 194 provides a push notification of a remote download instruction to the plurality of first information processing devices 10.

In the case where the plurality of first information processing devices 10 are registered in the notifying server 18, the user sets, in advance, one of the first information processing devices 10 as a terminal for downloading the contents. This setting is locally registered in the first information processing device 10 selected by the user. Accordingly, when each first information processing device 10 receives the remote download instruction, each first information processing device 10 determines whether or not the first information processing device 10 itself is set as a download terminal. Only the first information processing device 10 that determines that the first information processing device 10 itself is set as a download terminal can respond to the download instruction.

In the first information processing device 10, when the download processing unit 112 receives the download instruction, the download processing unit 112 send an inquiry to the management server 16 (S16). After the management server 16 performs user authentication using a token, and confirms that the contents are placed in the download queue, the management server 16 transmits an acknowledgment message to the first information processing device 10 (S18). When the download processing unit 112 in the first information processing device 10 receives the acknowledgment message, the download processing unit 112 transmits a download request to the management server (S20). Receiving the download request from the first information processing device 10, the management server 16 distributes content data to the first information processing device 10 (S22a and S22b).

While the contents are downloaded, the download condition notifying unit 114 periodically notifies download conditions to the management server 16 (S24a and S24b). The download conditions may be information indicating what percentage of data size of the whole of the contents has been downloaded. The user can start the application for remote operation on the second information processing device 12, access the management server 16, and check the download conditions.

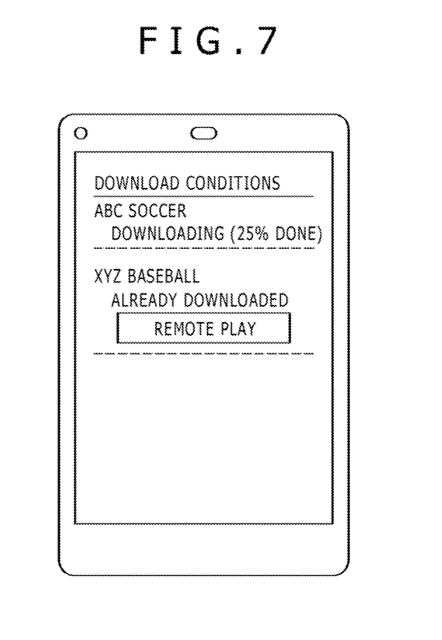

FIG. 7 shows an example of a download progress screen in the second information processing device 12. When the management server 16 receives an inquiry about the progress of the download from the download condition checking unit 153, the management server 16 notifies the download progress conditions to the notifying server 18 together with the identifying information of the second information processing device 12. Incidentally, the management server 16 may notify not only progress conditions with regard to the contents being downloaded now but also contents distributed to the first information processing device 10 by a remote download in the past. The notifying unit 194 in the notifying server 18 refers to the device information retaining unit 196, identifies the contact information of the second information processing device 12 from the identifying information of the second information processing device 12, and notifies the download progress conditions to the second information processing device 12. The download condition receiving unit 154 receives the download progress conditions. The notification processing unit 156 generates a progress screen, and displays the progress screen.

The download progress screen shown in FIG. 7 indicates that an “ABC soccer” game is being downloaded, that 25 percent has already been downloaded now, and that the download of a “XYZ baseball” game has been completed. Incidentally, a GUI for starting remote play processing when operated is also displayed for the already downloaded “XYZ baseball” game. Thus the user can check the download progress conditions by using the second information processing device 12 while the user is at a place distant from the first information processing device 10.

When the management server 16 determines that the download has been completed from the download conditions periodically notified from the first information processing device 10, the management server 16 notifies the completion of the download to the notifying server 18 together with the account ID of the user (S26). Incidentally, the management server 16 also transmits the identifying information of the second information processing device 12 that transmitted the download request in S10 to the notifying server 18 together with the notification of the completion of the download.

In the notifying server 18, the notifying unit 194 refers to the device information retaining unit 196, identifies the contact information of the second information processing device 12 from the identifying information of the second information processing device 12, and provides a push notification of the completion of the download to the second information processing device 12 (S28). When the download condition receiving unit 154 in the second information processing device 12 receives the conditions of the download of the contents in the first information processing device 10, the notification processing unit 156 notifies the received download conditions to the user (S30). In this case, the notification processing unit 156 notifies, as the download conditions, that the contents downloaded to the first information processing device 10 are in an executable state.

Incidentally, when the contents need to be installed on the first information processing device 10 so that the contents become executable, the download processing unit 112 in the first information processing device 10 may automatically install the contents after the download of the contents is completed. At this time, the download condition notifying unit 114 notifies the management server 16 that the installation is completed. When the management server 16 is notified that the installation is completed, the management server 16 notifies the notifying server 18 that the installation is completed together with the account ID of the user, and the notifying unit 194 may provide a push notification of the completion of the installation to the second information processing device 12. The notification processing unit 156 can thus notify that the contents downloaded to the first information processing device 10 are in an executable state.

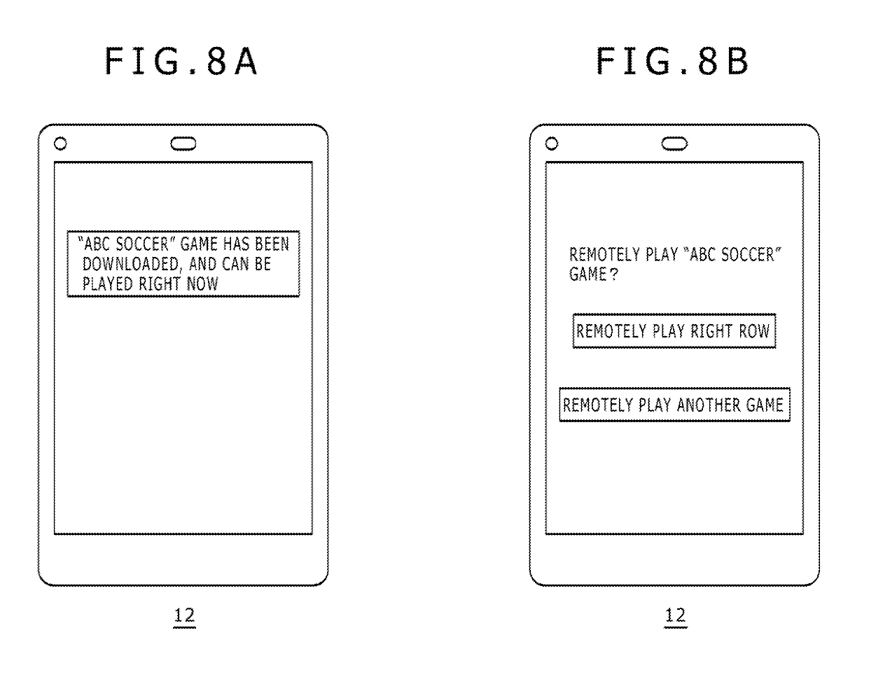

FIG. 8A shows an example of a notifying screen in the second information processing device 12. When the second information processing device 12 is in a standby state, the notification processing unit 156 displays, on a standby screen, a message indicating that the downloaded “ABC soccer” game is in a playable state. When the user taps a region displaying the message, the selecting operation receiving unit 158 receives the operation of selecting the message. This automatically starts the application for remote operation, and displays a remote operation screen on the display. In the present example, the region displaying the message constitutes a link for displaying the remote operation screen. However, the user may be allowed to select the message by operating the operating section of the second information processing device 12.

Incidentally, when the download condition receiving unit 154 receives the conditions of the download of the contents in the first information processing device 10 in a state in which the user is operating the remote operation application on the second information processing device 12, the notification processing unit 156 displays a message indicating that the game is in a playable state on the application screen. When the user taps the message display region, the selecting operation receiving unit 158 receives the operation of selecting the message, and the remote operation screen is displayed on the display.

FIG. 8B shows an example of the remote operation screen. When the user selects a GUI of “remotely play right now,” the remote play instruction receiving unit 160 receives the instruction for the remote play of the downloaded contents. The remote play instruction receiving unit 160 transmits the instruction for the remote play of the “ABC soccer” game to the first information processing device 10 via the network server together with an instruction for starting the first information processing device 10. The executing unit 116 in the first information processing device 10 automatically starts the “ABC soccer” game in a remote play mode. The game operation receiving unit 162 in the second information processing device receives a game operation from the user, and transmits information on the operation to the first information processing device 10. The executing unit 116 in the first information processing device 10 reflects the operation information from the second information processing device 12 in the progress of the game, and transmits an image of the game to the second information processing device 12. Thus, the user can enjoy the game by the remote play immediately after the completion of the remote download while the user is at a remote place.

The present technology has been described above on the basis of the embodiment thereof. It is to be understood by those skilled in the art that the present embodiment is illustrative, and that combinations of constituent elements and processing processes of the embodiment are susceptible of various modifications and that such modifications also fall within the scope of the present technology. In the embodiment, the notifying unit 194 notifies the download conditions to the second information processing device 12 that transmitted the download request in S10 in FIG. 6. However, the notifying unit 194 may notify the download conditions also to another registered terminal device of the user.

In addition, when the management server 16 receives the notification of the download conditions from the first information processing device 10, and determines that the contents are in an executable state, the management server 16 may notify the download conditions to the notifying server 18 at that point in time, and the notifying server 18 may notify the download conditions to the second information processing device 12. In a case where the game software has the mechanism disclosed in Patent Document 2, for example, when the management server 16 determines that all of the file group of a first group have been downloaded to the first information processing device 10, the management server 16 may notify the notifying server 18 that the contents are in an executable state at that point in time, and the notifying server 18 may notify the second information processing device 12 that the contents are in an executable state. Incidentally, in the embodiment, the management server 16 and the notifying server 18 are illustrated as separate servers. However, the functions of the notifying server 18 may be provided in the management server 16.

The application for remote operation may be able to access the management server 16 and indicate download order. When the user accesses the management server 16 and purchases a plurality of contents by operating the second information processing device 12, for example, remote download processing is performed in the order of the purchases. However, the user may want to immediately perform remote play of a game purchased second rather than a game purchased first. The application for remote operation therefore allows the user to set the order of priority in download. For example, the user can set the order of priority in download from the download progress screen shown in FIG. 7. When two contents are purchased, the download progress screen displays download conditions in order in which download is started from a top, and the user can change the display order by operating the operating section of the second information processing device 12, and thereby change the order of the download. Incidentally, the application for remote operation may display a not-yet downloaded content screen displaying a list of contents whose download is not completed, and the user may be allowed to set download order on the screen.

The present technology contains subject matter related to that disclosed in Japanese Priority Patent Application JP 2014-221916 filed in the Japan Patent Office on Oct. 30, 2014, the entire content of which is hereby incorporated by reference.

What is claimed is:

1. An information processing device comprising:
a request transmitting unit configured to transmit a request to download contents;
a condition receiving unit configured to receive download conditions of the contents in another terminal device than the information processing device; and
a notification processing unit configured to notify the received download conditions to a user.

2. The information processing device according to claim 1, wherein the information processing device is a portable device.

3. The information processing device according to claim 1, wherein the terminal device is a device registered as a download terminal by the user, and notifies the download conditions of the contents to a server, and the condition receiving unit receives the download conditions from the server.

4. The information processing device according to claim 1, wherein the notification processing unit notifies that the contents downloaded to the terminal device are in an executable state.

5. An information processing system comprising:
a first information processing device; and
a second information processing device;
the first information processing device including
a download processing unit configured to download contents from a server, and
a download condition notifying unit configured to notify download conditions of the contents to the server;
the second information processing device including
a request transmitting unit configured to transmit a request to download the contents to the server,
a condition receiving unit configured to receive the download conditions of the contents in the first information processing device from the server, and
a notification processing unit configured to notify the received download conditions to a user of the second information processing device.

6. A program for a computer, comprising:
transmitting a request to download contents to a server;
receiving download conditions of the contents in a terminal device; and
notifying the received download conditions to a user.
